(19) United States
(12) Patent Application Publication
(10) Pub. No.: US 2026/0196849 A1
(43) Pub. Date: Jul. 9, 2026

(54) MOBILE POWER STATION

(71) Applicant: Greenworks (Jiangsu) Co., Ltd, Changzhou (CN)

(72) Inventors: Zhenxing You, Changzhou (CN); Kai Wang, Changzhou (CN); Zehuan Zhou, Changzhou (CN); Nicholas Suchoza, Mooresville, NC (US)

(21) Appl. No.: 19/555,899

(22) Filed: Mar. 4, 2026

Related U.S. Application Data
(63) Continuation of application No. PCT/CN2023/117547, filed on Sep. 7, 2023.

(51) Int. Cl. H02J 7/34; B60J 5/04; B60P 1/43; B60Q 1/50; B62D 33/04; H02J 7/00; H02J 7/35; H02J 7/40; H02J 7/80; H02S 20/30; H04N 7/18

(52) U.S. Cl. CPC H02J 7/342; B60P 1/435; B60Q 1/50; B62D 33/042; H02J 7/35; H02J 7/40; H02J 7/80; H02J 7/865; H02S 20/30; B60J 5/0491; H04N 7/185

(57) ABSTRACT

A mobile power station is disclosed. The mobile power station includes an enclosure supported by a wheeled chassis; an electrical system positioned in the enclosure, the electrical system including an electrical storage unit configured to receive and supply electric energy; and a central processor configured to monitor a condition of the mobile power station and provide alerts to a user.

### CROSS REFERENCE TO RELATED APPLICATIONS

The present application is a Continuation application of PCT Application No. PCT/CN2023/117547 filed on Sep. 7, 2023, the contents of which are incorporated herein by reference in their entirety.

### BACKGROUND OF THE INVENTION

This invention relates generally to a mobile power station and more particularly to a mobile power station configured to receive and support outdoor power equipment, vehicles, and/or devices.

### BACKGROUND

Various types of vehicles are known for moving equipment. For example, vehicles such as utility trailers or trucks can be configured for various kinds of loads from general purpose configurations to more specialized configurations. It is common for utility trailers to be used to transport and store outdoor power equipment. However, conventional utility trailers are not configured to receive and efficiently charge and provide maintenance facilities for battery powered outdoor power equipment, vehicles, and/or devices because outdoor power equipment has generally utilized internal combustion engines.

One problem with known vehicles is that they do not provide an electrical power supply, specialized storage, and charging capabilities, for battery powered outdoor power equipment, vehicles, and/or devices.

### BRIEF SUMMARY OF THE INVENTION

These problems are addressed by a mobile power station that is configured to store and transport battery powered outdoor power equipment. More specifically the mobile power station disclosed herein is configured to provide charging capabilities both when the outdoor power equipment is in transport from one location to another location and when the mobile power station is parked.

According to one aspect of the invention, a mobile power station includes an enclosure supported by a wheeled chassis; an electrical system positioned in the enclosure, the electrical system including an electrical storage unit configured to receive and supply electric energy; and a central processor configured to monitor a condition of the mobile power station and provide alerts to a user.

According to one aspect of the technology described herein, a mobile power station includes an enclosure configured to be mounted on a wheeled chassis; an electrical system positioned in the enclosure, the electrical system including an electrical storage unit and is configured to receive and supply electric energy; and a central processor configured to monitor a condition of the mobile power station and provide alerts to a user, the central processor interconnecting security and operational devices to collect data and provide a user with up-to-date information on the condition of the mobile power station; and a video monitor configured to receive data from the central processor and display visual data.

According to another aspect of the technology described herein, a mobile power station includes an enclosure supported by a wheeled chassis; an electrical system positioned in the enclosure, the electrical system including an electrical storage unit configured to receive and supply electric energy; and a central processor configured to monitor a condition of the mobile power station and provide alerts to a user, the central processor interconnecting security and operational devices to collect data and provide a user with up-to-date information on the condition of the mobile power station.

### BRIEF DESCRIPTION OF THE DRAWINGS

The invention may be best understood by reference to the following description taken in conjunction with the accompanying drawing figures in which:

FIG. 1 is a front perspective view of a mobile power station in the form of a utility trailer;

FIG. 2 is a rear perspective view of the utility trailer of FIG. 1;

FIG. 3 is a top cross-sectional view of the utility trailer of FIG. 1;

FIG. 4 is a front cross-sectional view of the utility trailer of FIG. 1;

FIG. 5 is a rear view of the utility trailer of FIG. 1, with certain parts removed;

FIG. 6 is a left side cross-sectional view of the utility trailer of FIG. 1;

FIG. 7 is a right-side cross-sectional view of the utility trailer of FIG. 1; and

FIG. 8 is a flow chart of a control system of the utility trailer of FIG. 1.

### DETAILED DESCRIPTION OF THE INVENTION

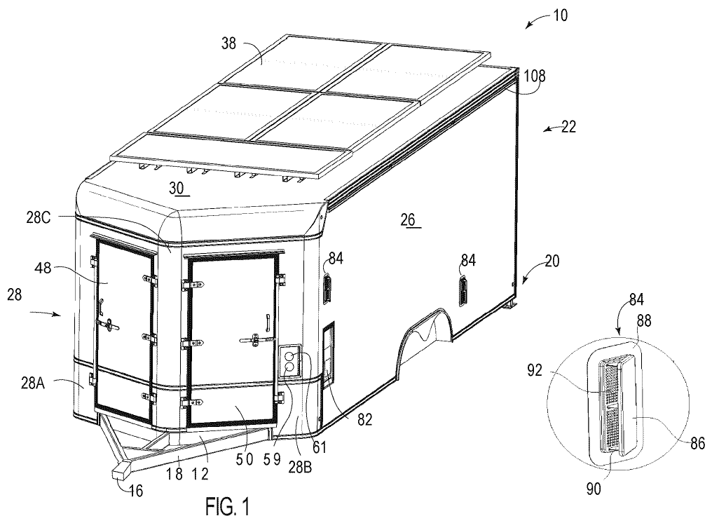

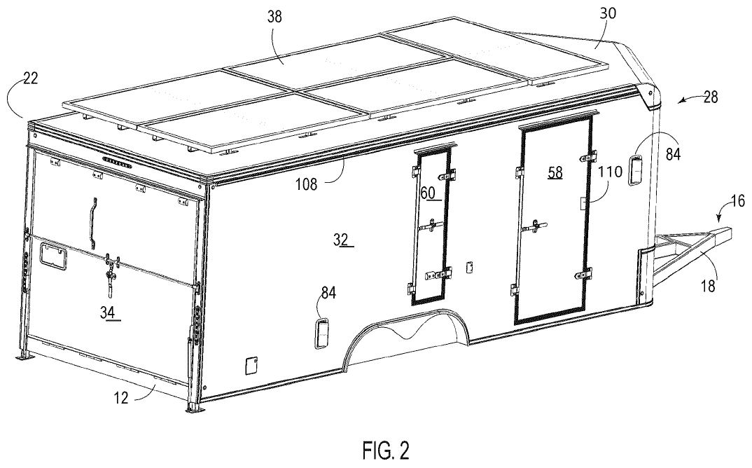

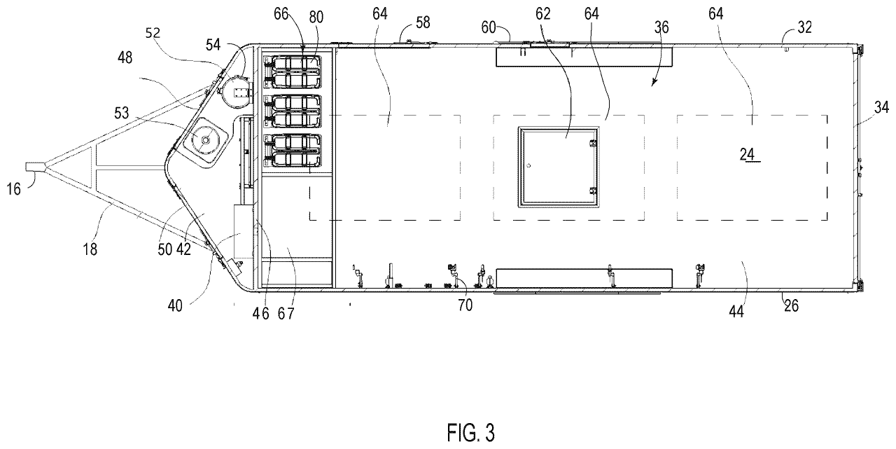

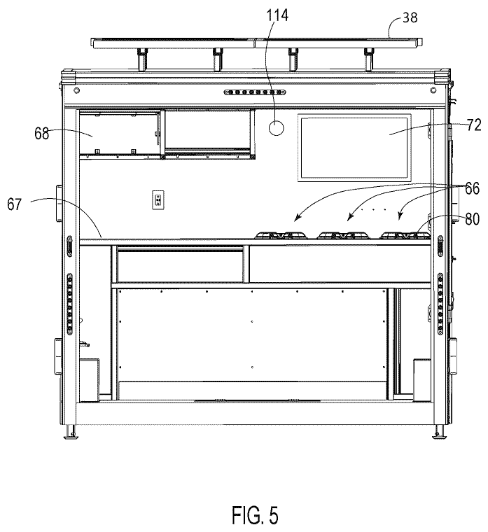

Referring to the drawings wherein identical reference numerals denote the same elements throughout the various views, FIGS. 1-7 show a representative embodiment of a mobile power station 10. Mobile power station 10 is configured to provide secure, productive, and efficient means to power a full array of battery powered outdoor equipment, vehicles, and/or devices.

As illustrated, the mobile power station 10 is a utility trailer; however, other forms of mobile power stations may be used, such as box trucks, pickup trucks, or other types of enclosures mounted to a wheeled chassis. For purposes of clarity, the term enclosure is defined as a surrounding that at least partially encloses an item and does not necessarily imply that it encloses on all sides.

The utility trailer 10 includes a wheeled chassis in the form of a frame 12 supported by at least one pair of wheels 14 mounted to the frame 12. It should be appreciated that the term wheeled chassis may also include a unit body structure where wheels are directly mounted to a body or enclosure and the body or enclosure act as the frame. It should be appreciated that the frame 12 may be made of steel, aluminum, or any other suitable material. The frame 12 extends from a hitch 16 connected to a tongue 18 of the frame 12 to a rear section 20. The hitch 16 allows the trailer 10 to be connected to a vehicle for towing.

The frame 12 supports an enclosure 22 having a floor 24, a left side wall 26, a front side wall 28, a roof 30, a right-side wall 32, and a rear wall 34. The front side wall 28 includes a first section 28A extending from right side wall 32 to a nose 28C of the front side wall 28 and a second section 28B extending from the left side wall 26 to the nose 28C. As shown, the first and second sections 28A, 28B extend outwardly from the left and right side walls 26, 32 at an angle and merge together at the nose 28C. The rear wall 34 is configured to operate as a door and ramp to allow access into an interior space 36 of the enclosure 22 of the trailer 10. This allows a user to load and unload equipment into the enclosure 22. An array of solar panels 38 is positioned on the roof 30. The solar panels 38 are configured to provide electricity to an electrical system 40.

The interior space 36 is divided into a first compartment 42 and a second compartment 44 by an interior wall 46. The first compartment 42 is defined by the front side wall 28 and the interior wall 46 and the second compartment 44 is defined by the interior wall 46, left side wall 26, right side wall 32, and rear wall 34.

The first compartment 42 is accessed by personnel doors 48 and 50. As shown, personnel door 48 is positioned in first section 28A and personnel door 50 is positioned in second section 28B. The first compartment 42 houses a beverage station 52 which allows multiple beverage coolers to be secured therein, reflective cones 53, and the electrical system 40. The first compartment 42 may also be used to store a tool box, fire suppression equipment, extension cords, or any other suitable equipment. As shown, beverage station 52 includes three beverage cooler racks 54 to safely secure three beverage coolers therein. It should be appreciated that any suitable number of beverage cooler racks 54 may be used. A partition wall 55 may be used to separate the beverage station 52 from the electrical system 40.

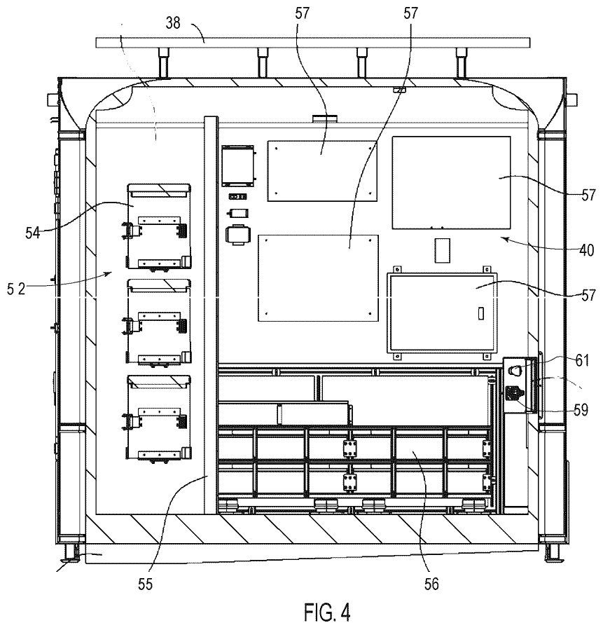

The electrical system 40 is accessed through the first compartment 42 and includes one or more battery packs 56 and multiple electrical system modules 57, as shown in FIG. 4. According to the illustrated embodiment, each battery pack 56 is a 400 V, high-output, automotive grade, 26 kwh battery pack with safe lithium iron phosphate (LFP) cell technology. The battery pack 56 is configured to be charged at a rate of up to 350 kw and is configured to be compatible with DC fast charging and/or 240 V charging using a standard J1772 plug 59, allowing the battery pack 56 to be fully charged in as little as thirty minutes. The battery pack 56 is also configured to be charged from the solar panels 38. According to the illustrated embodiment, the solar panels 38 provide 1200 W of output. It should be appreciated that other suitable solar panel outputs may be used. An emergency stop button 61 is also provided on the front side wall 28 to stop charging in the event of fire or other emergency.

The second compartment 44 is accessed by rear wall 34, personnel door 58 and access panel 60 located on the right side wall 32, and floor hatch 62 located in floor 24. As shown, the second compartment 44 includes three parking platforms and/or locations 64 for parking outdoor power equipment, such as a riding zero turn mower, thereon. It should be appreciated that the number of parking platforms 64 will depend on a length of the trailer 10.

The second compartment 44 houses a plurality of charging stations such as small equipment charging stations 66 positioned on a cabinet shelf 67, a general purpose storage cabinet 68, equipment racks 70, a video monitor 72, a plurality of charging banks 74, and other related equipment.

The electrical system 40 is configured to provide electrical power from the battery pack 56 to charging stations 66. The charging stations 66 charge individual batteries 80 for use in small equipment. The cabinet shelf 67 is positioned in the second compartment at the interior wall 46 and storage cabinet 68 is positioned on the interior wall 46 above the cabinet shelf 67. The electrical system 40 includes 24 kW of DC charging output, three individual 20 amp 120 V AC circuits and a 15 amp 12 V AC circuit for powering countertop outlets.

All charging stations of the trailer 10 are temperature controlled to provide safe and efficient charging. The utility trailer 10 includes a temperature control system 82 such as an air conditioner, heater, and/or combination air conditioner and heater. The temperature control system 82 is configured to keep major electronic components operating at optimal temperatures and allows for rapid charging handheld batteries at any environmental temperature. According to the illustrated embodiment, the temperature control system 82 is a 1500 BTU thermoelectric air conditioner; however, other suitable cooling and heating systems or ratings may be used.

Additionally, the trailer 10 includes a plurality of windows 84 to allow air to flow through the trailer 10. Each of the windows 84 include a window cover 86 pivotally connected to a window frame 88 by attachment plates 90 and a perforated grill 92. The perforated grill 92 allows air to flow through the perforations (apertures, slits, etc.) and into the interior space 36. The window cover 86 may be moved from a use position where the grill 92 is exposed to air flow and a non-use position where the grill 92 is covered by the window cover 86 and air is prevented from flowing through the grill 92 and into the interior space 36.

It is believed, that due to the provision of charging stations 66 and other charging stations, the trailer 10 can be used to reduce the number of necessary batteries needed to complete a typical day of work for a conventional yard crew by 60%.

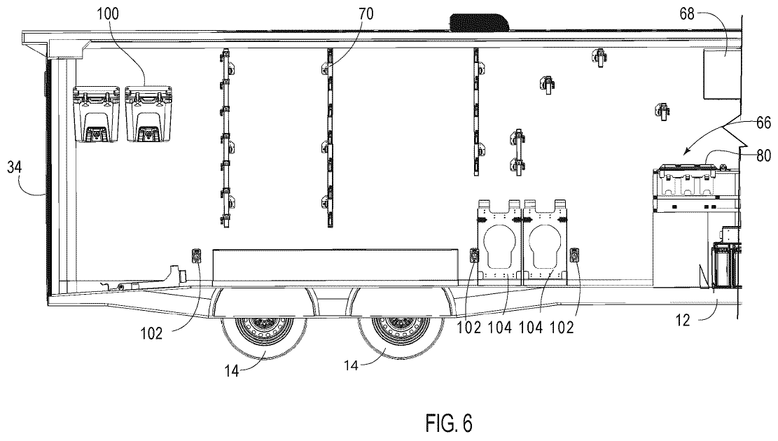

Equipment racks 70 are positioned within the interior space 36. The racks 70 are configured for the vertical storage of lawn equipment such as string trimmers and edgers and to provide electrical charging to lawn equipment stored there. As shown in FIG. 6, the racks 70 are mounted on an interior surface of the left side wall 26. At least one cooler or other storage container 100 may be mounted on the left side wall 26 between the racks 70 and the rear wall 34. Dedicated outdoor power equipment chargers 102 are provided on wall 26 and configured to provide electrical power to larger outdoor power equipment such as mowers. Additionally, two backpack blower mounts 104 are provided to store backpack blowers along wall 26.

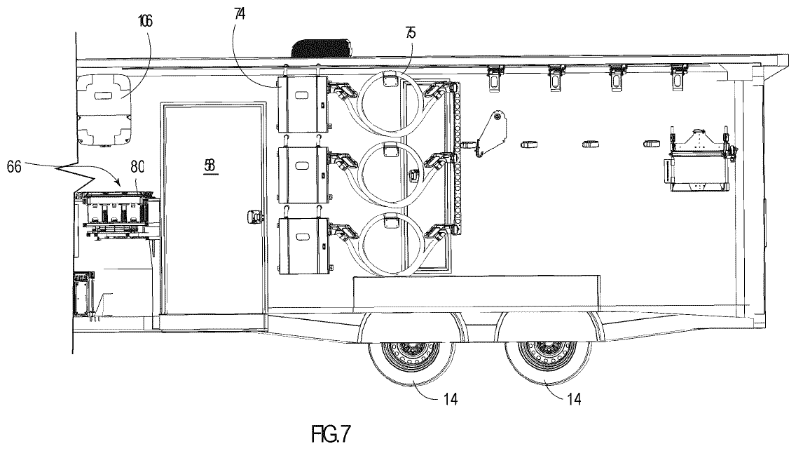

Referring now to FIG. 7, additional storage racks and charging equipment can be positioned on an interior surface of the right-side wall 32. Access panel 60 allows access to charging banks 74 within the trailer 10 by outdoor power equipment and other devices to be charged that are positioned outside of the trailer 10. In this way charging can be more efficiently managed during a workday by avoiding the requirement of loading vehicles into the trailer 10 to charge. Each of the charging banks 74 include at least one charging cable 75 for connection to a charging port of an outdoor power machine and/or equipment. As shown, the trailer 10 includes three charging banks 74 and three charging cables 75. The charging cables 75 may be of any suitable length to allow a user to charge an outdoor power machine external to the trailer 10, for example fifteen feet long.

Video monitor 72 is positioned on the interior wall 46. The video monitor 72 is configured to display metrics or visual information such as location, tool usage, battery charge levels, weather, temperatures, and individual test status on a live dashboard. The video monitor 72 is configured to display information received from multiple sources, including but not limited to: data storage incorporated into the video monitor 72, portable data storage such as a USB or thumb drive, computers, electronic devices, and the like. The video monitor 72 can be connected to such devices by the following: with hardware connection such as an ethernet cable, Wi-Fi, cell phone protocols such as 4G or 5G, and the like.

A central gateway 106 is positioned within interior space 36 and is configured to collect data regarding charging status, battery condition and the like (including the data displayed on video monitor 72) from the various chargers and outdoor power equipment within the trailer 10. The central gateway 106 includes one or more processors capable of executing ladder logic, programmed instructions, or some combination thereof. For example, it may be a general-purpose microcomputer of a known type, such as a PC-based computer, or may be a custom processor, or may incorporate one or more programmable logic controllers (PLC).

The utility trailer 10 is capable of being charged on any US-based EV charger and most workshop infrastructures via CCS combo type I plug J1772 (EV) or a Nema 14-50 outlet (240 V AC) and is capable of charging 25+ battery power tools, 36 handheld batteries, and three full-size mowers. Electrical connection 59 can be configured to include both inputs and outputs to provide for charging of the battery pack 56 from an external source of electrical energy and/or for powering the electrical system 40, as well as, for powering an external device such as a welder. Electrical sources of electrical energy include EV charging stations and electric power grids as well as any other suitable electrical sources.

An exterior light 108 is positioned along the top edge of the left side wall 26 and right side wall 32. In other embodiments, the exterior light 108 may be positioned along an exterior upper edge of at least one of the left side wall 26, the front wall 28, the right side wall 32, and the rear wall 34. As shown, the exterior light 108 is configured as a 19 foot long LED strip. The exterior light 108 is connected to the central gateway 106 of the trailer 10 and can be controlled by the central gateway 106 to indicate various status conditions such as electrical charge. For example, a continuous green light indicates the outdoor power machines are fully charged, a blinking green light indicates the outdoor power machines are in the process of being charged, and a continuous red light indicates a problem with charging. The exterior light 108 can also be utilized as a task light and a theft deterrent.

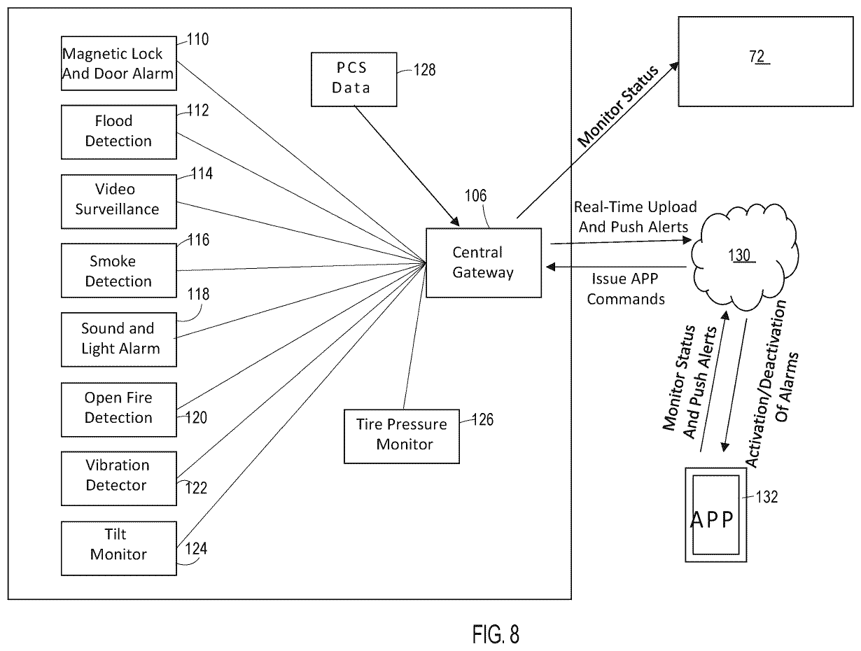

As shown in FIG. 8, the central gateway 106 interconnects various security and operational devices, collects data, provides alerts and monitoring information. As illustrated, the central gateway 106 may be connected to various sensors and cameras such as magnetic and/or electronic lock and door alarms 110 connected to doors and access panels to prevent them from being opened, a flood detector 112 to alert a user of water in the interior space 36, video surveillance camera 114 to record activity in the interior space 36, smoke detector 116 to alert a user of smoke and/or fire, sound and light alarm 118 to alert a user of an issue, open fire detector 120 to alert a user of a fire, a vibration detector 122 to detect unwanted vibrations in the trailer 10, a tilt monitor 124 to detect unsafe tilt angles of the trailer 10, a tire pressure monitor 126 to alert a user of a flat tire, PCS data 128, a cloud network 130 to push alerts, an APP installed on a mobile device 132 to receive alerts and activate or deactivate alarms, and the video screen 72 to display PCS data as described above.

PCS data may include current, voltage, power, and other relevant parameters in the process of charging and discharging, as well as, operational parameters of equipment being used, such as battery charge, speed of electric motor, and other relevant data generated during the operation of the equipment.

The magnetic lock and door alarms 110 are installed on doors or access points of the utility trailer 10 to allow multiple employees to enter the trailer without the need to keep doors unlocked throughout the day. The electronic locks can be configured with multiple codes for different personnel.

The sensor and cameras described above provide a complete security and data system to keep users informed of the status of the trailer security, battery charging, users accessing the trailer 10, etc. The central gateway 106 may use connectivity platforms such as Wi-Fi and/or cell phone protocols such as 4G or 5G, and the like to communicate with the cloud 130 to store data and push alerts to users through devices like mobile device 132. The central gateway 106 also collects PCS data to display on the video monitor 72.

In the event of an alarm or security event, the central gateway 106 receives the data and pushes the data to the cloud 130. The cloud 130 sends alerts to a user of the alarm or security event. The surveillance camera 114 takes screenshots and/or video of the alarm event and the central gateway 106 pushes the screenshot and/or video to a user to allow the user to visually review the alarm event. Screenshots and videos are automatically stored in the camera's data card. Data pushed by the central gateway 106 during an alarm may include the type of alarm (prying of door or access panel, water leak, battery fire, battery smoke, and personal intrusion into the interior of the trailer), information on the location of alarm, and live video of the alarm.

The foregoing has described a mobile power station configured for the storage and recharging of electrical outdoor power equipment. All of the features disclosed in this specification, and/or all of the steps of any method or process so disclosed, may be combined in any combination, except combinations where at least some of such features and/or steps are mutually exclusive. Each feature disclosed in this specification may be replaced by alternative features serving the same, equivalent or similar purpose, unless expressly stated otherwise. Thus, unless expressly stated otherwise, each feature disclosed is one example only of a generic series of equivalent or similar features.

The invention is not restricted to the details of the foregoing embodiment(s). The invention extends, or to any novel one, or any novel combination, of the steps of any method or process so disclosed.

What is claimed is:

1. A mobile power station, comprising:
an enclosure supported by a wheeled chassis;
an electrical system positioned in the enclosure, the electrical system including an electrical storage unit configured to receive and supply electric energy; and
a central processor configured to monitor a condition of the mobile power station and provide alerts to a user.

2. The mobile power station according to claim 1, wherein the enclosure includes an interior space divided into a first compartment and a second compartment.

3. The mobile power station according to claim 1, wherein the enclosure includes a rear wall configured to provide a ramp for loading and unloading equipment into the enclosure.

4. The mobile power station according to claim 1, further including at least one solar panel connected to the enclosure to supply electrical energy to the electrical system.

5. The mobile power station according to claim 1, further including at least one charging bank electrically connected to the electrical system, the at least one charging bank configured to transmit electric energy from the electrical system to an electric device.

6. A mobile power station, comprising:
an enclosure supported by a wheeled chassis;
an electrical system positioned in the enclosure, the electrical system including an electrical storage unit configured to receive and supply electric energy; and
a central processor configured to monitor a condition of the mobile power station and provide alerts to a user, the central processor interconnecting security and operational devices to collect data and provide a user with up-to-date information on the condition of the mobile power station.

7. The mobile power station according to claim 6, further including a temperature control system to maintain an operating temperature of the electrical system.

8. The mobile power station according to claim 6, further including at least one charging station connected to the electrical system, the at least one charging station configured to charge at least one battery.

9. The mobile power station according to claim 6, wherein the data includes battery charge levels.

10. The mobile power station according to claim 6, wherein the central processor uploads alerts and the collected data to a cloud network, the cloud network providing access to the alerts and data by a user.

11. The mobile power station according to claim 6, further including at least one surveillance camera positioned in the enclosure and connected to the central processor, the surveillance camera providing video of an interior of the enclosure to a user.

12. The mobile power station according to claim 6, further including a vertical storage system configured to store multiple electric devices along a wall of the enclosure.

13. A mobile power station, comprising:
an enclosure configured to be mounted on a wheeled chassis;
an electrical system positioned in the enclosure, the electrical system including an electrical storage unit and is configured to receive and supply electric energy;
a central processor configured to monitor a condition of the mobile power station and provide alerts to a user, the central processor interconnecting security and operational devices to collect data and provide a user with up-to-date information on the condition of the mobile power station; and
a video monitor configured to receive data from the central processor and display visual data.

14. The mobile power station according to claim 13, wherein the visual data is selected from the group consisting of location, tool usage, battery charge levels, weather, and temperatures.

15. The mobile power station according to claim 13, further including at least one charging bank electrically connected to the electrical system, the at least one charging bank configured to transmit electric energy from the electrical system to an electric device.

16. The mobile power station according to claim 15, further including an access panel in a wall of the enclosure, the access panel providing access to the at least one charging bank externally of the enclosure, wherein the at least one charging bank includes at least one charging cable and wherein the at least one charging cable is configured extend through the access panel to charge an electric device residing externally of the enclosure.

17. The mobile power station according to claim 13, further including at least one charging station electrically connected to the electrical system, the at least one charging station configured to charge at least one battery.

18. The mobile power station according to claim 13, further including a vertical storage system configured to store multiple electric devices along a wall of the enclosure.

19. The mobile power station according to claim 13, further including a light strip along an exterior of the enclosure, the light strip providing a visual indication of charging.

20. The mobile power station according to claim 13, further including a security system connected to the central processor, the security system including components selected from the group consisting of a surveillance camera, a magnetic door alarm, a tilt monitor, a flood detector, and a fire detector.
